(19) United States
(12) Patent Application Publication
(10) Pub. No.: US 2015/0212443 A1
(43) Pub. Date: Jul. 30, 2015

(54) TONER FOR ELECTROSTATIC CHARGE IMAGE DEVELOPMENT, TWO-COMPONENT DEVELOPER, AND METHOD FOR FORMING IMAGE

(71) Applicant: Konica Minolta, Inc., Tokyo (JP)

(72) Inventors: Koji Shibata, Tokyo (JP); Satoshi Uchino, Tokyo (JP); Kosuke Nakamura, Tokyo (JP)

(21) Appl. No.: 14/605,155

(22) Filed: Jan. 26, 2015

(30) Foreign Application Priority Data
Jan. 29, 2014 (JP) 2014-014130

(51) Int. Cl. G03G 9/00

(52) U.S. Cl. CPC G03G 9/08755; G03G 9/08728

(57) ABSTRACT

To provide a toner for electrostatic charge image development, a two-component developer, and a method for forming an image in which a high quality image can be stably obtained by suppression of a decrease in image density as caused by excessive electrification in a low temperature and low humidity environment, prevention of fogging as caused by lowered electrification property in a high temperature and high humidity environment, and suppression of a difference in image density.

A toner for electrostatic charge image development which contains toner particles containing at least a binder resin and external additives containing metal salts of fatty acid, in which a ratio of the metal salts of fatty acid that are liberated by a centrifugal treatment in an aqueous dispersion is 30 to 80% and the number average particle diameter of the particles that are present in a supernatant after the centrifugal treatment is 0.7 μm to 3.0 μm, the ratio and the number average particle diameter of the particles being measured by the centrifugation of the aqueous dispersion of the toner, and the binder resin present on a surface of the toner particles contains a vinyl polymer part and a polyester part.

### BACKGROUND

1. Technical Field

The present invention relates to a toner for electrostatic charge image development (hereinafter, also simply referred to as a “toner”) used for forming an image by electrophotographic method, a two-component developer containing the toner, and a method for forming an image using the two-component developer.

2. Description of Related Art

According to wider use of digital printing, high image quality, energy saving, and high image stability are required more than ever.

In the field of a toner, a toner with low temperature fixability which can be fixed with low energy is being developed from the viewpoint of saving energy. In order to obtain a toner with low fixing temperature, it is necessary to lower the melting temperature or melting viscosity of a binder resin. Compared to a styrene-acrylic copolymer resin which has been used as a binder resin in the past, a polyester resin is advantageous in that it allows easy design of low softening point while maintaining high glass transition point. As such, a toner using a polyester resin can have excellent low temperature fixability and excellent heat resistant storability.

Meanwhile, since the toner using a polyester resin has an extremely high negative electrification property compared to a toner in which a styrene-acrylic copolymer resin is used, the toner tends to get over-electrified under an environment of low temperature and low humidity, in particular. When the electrification amount is excessive, electrostatic adhesive forces increase, and thus it is necessary to have excess electric field strength for developing a required amount of a toner. There is also a problem that, as the toner remains on a photoreceptor without being fully and completely transferred, a decrease in density of a printed image is caused as a result.

When a two-component developer is used for a long period of time, the electrification property tends to be lowered under an environment of high temperature and high humidity, in particular, as external additives are buried in a surface of toner particles. Once the electrification property is lowered, there is a problem that toner fogging or the like are caused. Even for a case in which a polyester resin having high electrification property is used as a binder resin, lower electrification property caused by buried external additives cannot be avoided.

From the viewpoint of a cleaning property of a photoreceptor, a lubricating agent may be sometimes needed for an apparatus for forming an image by electrophotographic method. When a lubricant is used by being added to a toner, there are cases in which it is not evenly coated on a photoreceptor. As a result, there is a problem that a difference in image density occurs between a portion with a lubricating agent and a portion without a lubricating agent. In particular, since the lubricating agent easily degrades by an electrification method which uses an electrifying roller, a significant difference in image density occurs.

In Japanese Patent Application Publication No. 2010-102057, a toner in which a lubricating agent composed of metal salts of fatty acid with small particle diameter is used for obtaining low temperature fixability and cleaning property is disclosed. Further, in Japanese Patent Application Publication No. 2013-164477, a toner with defined liberation ratio of metal salts of fatty acid is disclosed.

However, all the aforementioned problems cannot be solved by any toner disclosed in Japanese Patent Application Publication No. 2010-102057 or Japanese Patent Application Publication No. 2013-164477.

### SUMMARY

The present invention is devised in consideration of the circumstances described above, and a purpose of the invention is to provide a toner for developing an electrostatic latent image, a two-component developer, and a method for forming an image in which a high quality image can be stably obtained by suppression of a decrease in image density as caused by excessive electrification in a low temperature and low humidity environment, prevention of fogging as caused by lowered electrification property in a high temperature and high humidity environment, and suppression of a difference in image density.

Among the above purpose, to reach at least one purpose, a toner for electrostatic charge image development which reflects one aspect of the present invention is a toner for electrostatic charge image development which includes toner particles containing at least a binder resin and external additives containing metal salts of fatty acid, wherein

a ratio of the metal salts of fatty acid that are liberated by a centrifugal treatment in an aqueous dispersion is 30 to 80% and the number average particle diameter of the particles that are present in a supernatant after the centrifugal treatment is 0.7 μm to 3.0 μm, the ratio and the number average particle diameter of the particles being measured by the centrifugation of the aqueous dispersion of the toner, and

the binder resin present on a surface of the toner particles contains a vinyl polymer part and a polyester part.

The details of certain exemplary, non-limiting embodiments of the invention are set forth in the description below. Other features or advantages of the present invention will be apparent from the following drawings and detailed description of several examples, and also from the appended claims.

### DETAILED DESCRIPTION

Hereinbelow, the present invention will be described in detail.

In the first embodiment of the present invention, there is provided a toner for electrostatic charge image development which includes toner particles containing at least a binder resin and external additives containing metal salts of fatty acid, wherein

a ratio of the metal salts of fatty acid that are liberated by a centrifugal treatment in an aqueous dispersion is 30 to 80% and the number average particle diameter of the particles that are present in a supernatant after the centrifugal treatment is 0.7 μm to 3.0 μm, the ratio and the number average particle diameter of the particles being measured by the centrifugation of the aqueous dispersion of the toner, and

the binder resin present on a surface of the toner particles contains a vinyl polymer part and a polyester part.

According to the toner for electrostatic charge image development in the first embodiment of the present invention, a high quality image can be stably obtained by suppression of a decrease in image density as caused by excessive electrification in a low temperature and low humidity environment, prevention of fogging as caused by lowered electrification property in a high temperature and high humidity environment, and suppression of a difference in image density.

In the toner for electrostatic charge image development according to the first embodiment of the present invention, the ratio of the metal salts of fatty acid that are liberated by a centrifugal treatment in an aqueous dispersion of the toner is preferably 40 to 70%.

In the toner for electrostatic charge image development according to the first embodiment of the present invention, the number average particle diameter of the particles that are present in a supernatant after the centrifugal treatment is preferably 0.8 μm to 2.0 μm.

In the toner for electrostatic charge image development according to the first embodiment of the present invention, the vinyl polymer part and the polyester part preferably bind to each other.

In the toner for electrostatic charge image development according to the first embodiment of the present invention, the metal salts of fatty acid are preferably added at a ratio of 0.01 to 0.50 parts by weight relative to 100 parts by weight of the toner particles.

In the toner for electrostatic charge image development according to the first embodiment of the present invention, the metal salts of fatty acid are preferably at least one type selected from zinc stearate, lithium stearate, and calcium stearate.

In the toner for electrostatic charge image development according to the first embodiment of the present invention, the metal salts of fatty acid are preferably zinc stearate.

Among the above purpose, to reach at least one purpose, a two-component developer which reflects one aspect of the present invention is a two-component developer including a toner for electrostatic charge image development and a carrier for electrostatic charge image development, wherein the toner for electrostatic charge image development is the toner for electrostatic charge image development of the first embodiment described above.

According to the two-component developer of the second embodiment, as the aforementioned toner of the first embodiment is contained in the two-component developer, a high quality image can be stably obtained by suppression of a decrease in image density as caused by excessive electrification in a low temperature and low humidity environment, prevention of fogging as caused by lowered electrification property in a high temperature and high humidity environment, and suppression of a difference in image density.

Among the above purpose, to reach at least one purpose, a method for forming an image which reflects one aspect of the present invention is a method for forming an image by using the two-component developer of the second embodiment described above, the method including a step of electrifying a surface of a photoreceptor by an electrifying roller which is installed to be in contact with the photoreceptor.

According to the method for forming an image of the third embodiment, as the aforementioned two-component developer of the second embodiment is used for the method, a high quality image can be stably obtained by suppression of a decrease in image density as caused by excessive electrification in a low temperature and low humidity environment, prevention of fogging as caused by lowered electrification property in a high temperature and high humidity environment, and suppression of a difference in image density even for an electrifying mode in which an electrifying roller is used.

### <<Toner for Electrostatic Charge Image Development>>

The toner of the first embodiment contains toner particle containing at least a binder resin and external additives containing metal salts of fatty acid.

Preferably, the toner of the first embodiment essentially consists of toner particle containing at least a binder resin and external additives containing metal salts of fatty acid. If required, the toner particles may also contain a colorant, a releasing agent, a charge controlling agent, or the like. Further, the external additives may also contain a component other than the metal salts of fatty acid.

According to the toner of the present invention, the toner particle may have a monolayer structure, a core-shell structure, a multilayer structure, or a domain-matrix structure.

According to the toner of the present invention, the ratio of the metal salts of fatty acid that are liberated by a centrifugal treatment in an aqueous dispersion of the toner (hereinbelow, also referred to as “liberation ratio of the metal salts of fatty acid”) is 30 to 80%, and preferably 40 to 70%, and the number average particle diameter of the particles that are present in a supernatant after the centrifugal treatment (hereinbelow, also referred to as “supernatant particles”) is 0.7 μm to 3.0 μm, and preferably 0.8 μm to 2.0 μm.

When the liberation ratio of the metal salts of fatty acid is within the above range, the carrier constituting the two-component developer can be maintained to have a high positive electrification property, and thus a decrease in the electrification property of the toner in a high temperature and high humidity environment can be suppressed during the use for a long period of time. In this regard, it is believed that, as the metal salts of fatty acid generally have a higher positive electrification property than a carrier, the metal salts of fatty acid liberated from toner particles adhere to the carrier and disperse to coat the carrier surface, and thus the positive electrification property of the carrier is maintained. Further, due to an even supply amount of the metal salts of fatty acid to a photoreceptor, a difference in image density can be suppressed. In this regard, it is believed that, when the liberation ratio of the metal salts of fatty acid is within the aforementioned range, the metal salts of fatty acid adhered on toner particles can be easily supplied to a photoreceptor in a portion of a photoreceptor on which an image is to be formed (hereinbelow, referred to as an “image part”) while the metal salts of fatty acid in liberated state can be easily supplied to a photoreceptor in a portion of a photoreceptor on which an image is not to be formed (hereinbelow, referred to as a “non-image part”), yielding suppressed deviation in supply amount of the metal salts of fatty acid between the image part and non-image part on a photoreceptor. In the toner for electrostatic charge image development of the first embodiment, the ratio of the metal salts of fatty acid that are liberated by a centrifugal treatment in an aqueous dispersion of the toner is preferably 40 to 70%.

Further, when the number average particle diameter of the supernatant particles is 0.7 μm or more, excessive electrification at early stage in a low temperature and low humidity environment can be suppressed. On the other hand, when the number average particle diameter of the supernatant particles is 3.0 μm or less, efficient coating of a carrier surface can be achieved so that a decrease in the electrification property of the toner in a high temperature and high humidity environment can be suppressed even during the use for a long period of time. In the toner for electrostatic charge image development of the first embodiment, the number average particle diameter of the particles that are present in a supernatant after the centrifugal treatment is preferably 0.8 μm to 2.0 μm.

Specific details of the method for measuring the ratio of metal salts of fatty acid that are liberated by a centrifugal treatment are as follows. 3 g of the toner, 35 ml of 0.2% aqueous solution of polyoxyethyl phenyl ether, and 2.0 cm stirrer chip are added to a 100 ml beaker and stirred for 10 minutes at 1000 rpm to prepare an aqueous dispersion of toner. After that, the aqueous dispersion of toner is transferred to a 50 ml screw tube and subjected to the centrifugal treatment (1) for 2 minutes at 1000 rpm by using the centrifuge “H-900” (manufactured by KOKUSAN Co., Ltd.). After that, the supernatant is pipetted off and stirring is performed in 100 ml beaker for 5 minutes at 1000 rpm after adding 35 ml of pure water. The centrifugal treatment (2) is performed again. The operation from the removal of supernatant to the centrifugal treatment (2) is repeated three times. After that, the supernatant is pipetted off again and stirring is performed in 100 ml beaker for 5 minutes at 1000 rpm after adding 35 ml of pure water. Then, filtration using a filter cloth with mesh size of 1 μm is performed. Washing is performed at the time of filtration by using 100 ml of water. After that, drying by suction is performed.

The toner obtained after drying by suction and an unused toner are subjected to the measurement of NET strength of the metal by using a fluorescence X ray analyzer “XRF-1700” (manufactured by Shimadzu Corporation). The obtained value is taken as the amount of the metal salts of fatty acid and the liberation ratio is calculated based on the following formula (1). Specific procedures for measuring the NET strength are as follows: 2 g of a toner is pelletized by pressurizing for 10 seconds with a load of 15 t and the measurement is performed by qualitative and quantitative analysis according to the following conditions. Meanwhile, for the measurement, Kα peak angle of an element for measurement (metal elements derived from the metal salts of fatty acid) was determined from the 20 table and used.

### —Measurement Conditions—

Slit: standard
Attenuator: no
Spectrophotometric crystals (Ti=LiF, Si=PET)
Detector (Ti=SC, Si=FPC)

Liberation ratio (%)=(Amount of metal salts of fatty acid in toner after drying by suction)/(Amount of metal salts of fatty acid in unused toner)×100 Formula (1):

As described herein, the “unused toner” is the same as the toner subjected to the centrifugal treatment, and it indicates a toner in a toner bottle before use (with the proviso that, in case of containing a carrier, it indicates a toner after removal of the carrier by using a magnet or the like).

Specific details of the method for measuring the number average particle diameter of the particles that are present in a supernatant are as follows. With regard to the method for measuring the ratio of the metal salts of fatty acid that are liberated by the aforementioned centrifugal treatment, a flow type particle image analyzer “FPIA-2100” (manufactured by Sysmex Corporation) is used for the supernatant after the initial centrifugal treatment (1) and the measurement range of 0.6 to 400 μm is employed. Meanwhile, the external additives other than the metal salts of fatty acid that are included in the toner have a size of 0.6 μm or less as described below, and thus the particles derived from the external additives are not measured. Accordingly, the particle size distribution measured within the aforementioned range corresponds to the particle size distribution of the particles of the metal salts of fatty acid.

The liberation ratio of the metal salts of fatty acid can be controlled based on the mixing time when the metal salts of fatty acid are added. Longer mixing time leads to stronger adhesion for the metal salts of fatty acid onto the toner particles, thus yielding lower liberation ratio.

The number average particle diameter of the supernatant particles can be also controlled based on the particle diameter of the metal salts of fatty acid that are used.

### <Binder Resin>

With regard to the toner of the first embodiment, the binder resin present on a surface of the toner particles (hereinbelow, also referred to as a “surface resin”) is not particularly limited, when the binder resin contains a vinyl polymer part and a polyester part. The vinyl polymer part and polyester part indicate a vinyl resin and a polyester resin, respectively, when the vinyl polymer part and polyester part do not bind to each other. When the vinyl polymer part and polyester part bind to each other, the resin indicates a composite resin in which a vinyl polymerization segment and a polyester polymerization segment chemically bind to each other via a both reactive monomer, the vinyl polymerization segment indicates the vinyl polymer part and the polyester polymerization segment indicates the polyester part. In the first embodiment, the surface resin is preferably a composite resin in which a vinyl polymerization segment and a polyester polymerization segment bind to each other.

As the surface resin of the first embodiment contains both the vinyl polymer part and the polyester part, a decrease in image density as caused by excessive toner electrification at initial stage under a low temperature and low humidity environment can be suppressed, in particular. That is because, due to the co-presence of the polyester part and the vinyl polymer part which has a low electrification property than the polyester part on a surface of the toner particles, the electrification property of the toner can be controlled without sacrificing the low temperature fixability. In particular, when the surface resin is a composite resin in which a vinyl polymerization segment and a polyester polymerization segment bind to each other, the electrification property of the toner can be maintained more stably. Further, when the toner particles, metal salts of fatty acid, and carrier are admixed with another in a developing machine, the electrostatic adhesion force between the toner particles and metal salts of fatty acid is lowered due to the presence of the vinyl polymer part on a surface of the toner particles. As such, it becomes easier for the metal salts of fatty acid to migrate to the carrier, and therefore a decrease in electrification property of the toner under a high temperature and high humidity environment can be further suppressed.

The vinyl polymer part (vinyl resin or vinyl polymerization segment) is obtained by using a vinyl polymerizable monomer. Examples of the vinyl polymerizable monomer include a monomer having an ethylenically unsaturated bond capable of allowing radical polymerization such as aromatic vinyl monomer or (meth)acrylic ester monomer.

Examples of the aromatic vinyl monomer include styrene, o-methyl styrene, m-methyl styrene, p-methyl styrene, p-methoxystyrene, p-phenyl styrene, p-chlorostyrene, p-ethyl styrene, p-n-butyl styrene, p-tert-butyl styrene, p-n-hexyl styrene, p-n-octyl styrene, p-n-nonyl styrene, p-n-decyl styrene, p-n-dodecyl styrene, 2,4-dimethyl styrene, 3,4-dichlorostyrene, and their derivatives, or the like. It can be used singly or in combination of two or more types.

Examples of the (meth)acrylic ester monomer include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, and diethylaminoethyl methacrylate, or the like. It can be used singly or in combination of two or more types.

Of the foregoing monomers, the combined use of an aromatic vinyl monomer and a (meth)acrylic acid ester monomer is preferred.

There may be used a third vinyl monomer as the vinyl polymerizable monomer. Examples of the third vinyl monomer include an acid monomer such as acrylic acid, methacrylic acid, maleic acid anhydride, and vinyl acetic acid, acrylamide, methacrylamide, acrylonitrile, ethylene, propylene, butylene, vinyl chloride, N-vinylpyrrolidone and butadiene.

There may be used a poly-functional vinyl monomer as the vinyl polymerizable monomer. Examples of the poly-functional vinyl monomer include a diacrylate of ethylene glycol, propylene glycol, butylene glycol or hexylene glycol; divinylbenzene, and a dimethacrylate or a trimethacrylate of a tertiary or higher alcohol such as pentaerythritol or trimethylol propane.

The polyester part (polyester resin or polyester polymerization segment) is obtained by a polycondensation reaction in the presence of an appropriate catalyst by using, as raw materials, a polyhydric carboxylic acid monomer (or its derivatives) and a polyhydric alcohol monomer (or its derivatives).

Examples of the polyhydric carboxylic acid monomer derivative which may be used include an alkyl ester, an acid anhydride or an acid chloride of a polyhydric carboxylic acid and examples of the polyhydric alcohol monomer derivative which may be used include an ester compound of a polyhydric alcohol monomer and a hydroxycarboxylic acid.

Examples of the polyhydric carboxylic acid monomer include divalent carboxylic acid such as oxalic acid, succinic acid, maleic acid, adipic acid, β-methyl adipic acid, azelaic acid, sebacic acid, nonane dicarboxylic acid, decane dicarboxylic acid, undecane dicarboxylic acid, dodecane dicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucic acid, phthalic acid, isophthalic acid, terephthalic acid, tetrachlorophthalic acid, chlorophthalic acid, nitrophthalic acid, p-carboxyphenylacetic acid, p-phenylene-diacetic acid, m-phenylene-di-glycolic acid, p-phenylene-di-glycolic acid, o-phenylene-di-glycolic acid, diphenylacetic acid, diphenyl-p,p′-dicarboxylic acid, naphthalene-1,4-dicarboxylic acid, napthalene-1,5-dicarboxylic acid, naphthalene-2,6-dicarboxylic acid, anthracene dicarboxylic acid, or dodecenyl succinic acid; and trivalent carboxylic acid such as trimellitic acid, pyromellitic acid, naphthalene tricarboxylic acid, naphthalene tetracarboxylic acid, pyrene-tricarboxylic acid, or pyrene-tetracarboxylic acid. It can be used singly or in combination of two or more types.

Examples of the polyhydric alcohol monomer include divalent alcohols such as ethylene glycol, propylene glycol, butanediol, diethylene glycol, hexanediol, cyclohexanediol, octanediol, decanediol, dodecanediol, an ethylene oxide adduct of bisphenol A, or a propylene oxide adduct of bisphenol A; and trivalent polyols such as glycerin, pentaerythritol, hexamethylol melamine, hexaethylol melamine, tetramethylol benzoguanamine, or tetraethylol benzoguanamine. It can be used singly or in combination of two or more types.

When the vinyl polymer part and the polyester part do not bind to each other in the surface resin, the weight ratio between the vinyl resin and the polyester resin (vinyl resin/polyester resin) is preferably 50/50 to 3/97, and more preferably 40/60 to 5/95.

In the case that the vinyl polymer part and the polyester part do not bind to each other, the weight ratio between the vinyl resin and the polyester resin on the surface resin is measured by follows. The obtained particles are stained with ruthenium (VIII) oxide or osmium (VIII) oxide (preferably ruthenium (VIII) oxide), and are observed by transmission electron microscopy (TEM). Because of the difference stained form (color) between the vinyl polymer part and the polyester part, the weight ratio thereof is calculated by image analysis. Specifically, the surface is defined as the surface which is within 300 nm from the surface layer, each areas of the vinyl polymer part and the polyester part within 300 nm from the surface layer is measured, and the weight ratio regards as the area ratio. Accordingly, the weight ratio between the vinyl resin and the polyester resin is obtained.

In the case that the vinyl polymer part and the polyester part do not bind to each other, as for the method for manufacturing a binder resin having a vinyl polymer part and the polyester part, the following methods can be mentioned.
(1) A method in which each of resin microparticles including the vinyl polymer part and resin microparticles including the polyester part are prepared, after either of resin microparticles including the vinyl polymer part or resin microparticles including the polyester part are subjected to particle growth, another resin microparticles are added thereto.
(2) A method in which each of resin microparticles including the vinyl polymer part and resin microparticles including the polyester part are prepared, and both of resin microparticles including the vinyl polymer part and resin microparticles including the polyester part are added at a time, and subjected to particle growth.

The method for preparing resin microparticles including the vinyl polymer part and resin microparticles including the polyester part is not particularly limited, well-known methods are applied.

When the surface resin is a composite resin in which the vinyl polymerization segment and the polyester polymerization segment bind to each other, the ratio of the vinyl polymerization segment is preferably 5 to 30% by weight relative to the total weight of the vinyl polymerization segment and the polyester polymerization segment.

The ratio of the vinyl polymerization segment of the composite resin relative to the total weight of the vinyl polymerization segment and the polyester polymerization segment is obtained by calculating the entire components constituted of the vinyl polymerization segment relative to the sum of the entire components (total amount of raw material) constituted of the vinyl polymerization segment and the entire components (total amount of raw material) constituted of the polyester polymerization segment.

For a case in which the surface resin is a composite resin having the vinyl polymerization segment and the polyester polymerization segment chemically bound to each other via a both reactive monomer, the both reactive monomer indicates a compound which has, in the molecule, at least one functional group selected from a group consisting of a hydroxyl group, a carboxy group, an epoxy group, a primary amino group, and a secondary amino group; and an ethylenically unsaturated bond. A hydroxyl group and a carboxy group are preferred as a functional group. More preferably, it is a carboxy group. In other words, the both reactive monomer is preferably a vinyl-based carboxylic acid.

Examples of the both reactive monomer include acrylic acid, methacrylic acid, fumaric acid, and maleic acid. It can be also a hydroxylalkyl (carbon number of 1 to 3) ester thereof. From the viewpoint of the reactivity, acrylic acid, methacrylic acid, and fumaric acid are preferable. Further, as a both reactive monomer, it is preferable to use a monovalent vinyl-based carboxylic acid instead of poly-functional vinyl-based carboxylic acid from the viewpoint of durability, because the monovalent vinyl-based carboxylic acid is believed to be more suitable for obtaining a composite as it has a higher reactivity with a monomer as raw materials of an addition polymerization resin (vinyl polymerization segment). Meanwhile, when dicarboxylic acid like fumaric acid is used as a both reactive monomer, slightly poor durability is yielded, because the dicarboxylic acid is believed to be less suitable for obtaining a homogeneous composite as it has a lower reactivity with a monomer as raw materials of an addition polymerization resin, thus yielding a domain structure.

The use amount of the both reactive monomer is, from the viewpoint of improving the low temperature fixability, off-set property against high temperature, and durability of the toner, preferably 1 to 10 parts by weight and more preferably 4 to 8 parts by weight relative to 100 parts by weight of the total amount of a monomer as raw materials of an addition polymerization resin. Further, relative to 100 parts by weight of the total amount of a monomer as raw materials of a polycondensation resin (polyester polymerization segment), it is preferably 0.3 to 8 parts by weight and more preferably 0.5 to 5 parts by weight.

As for the method for manufacturing a composite resin in which a vinyl polymerization segment and a polyester polymerization segment bind to each other, the following three methods can be mentioned.
(1) A method in which a polycondensation reaction is carried out after performing an addition polymerization reaction, and if necessary, by adding a monomer with valency of three or higher as raw materials of a polycondensation resin to be a cross-linking agent to a reaction system, the polycondensation is further performed.
(2) An addition polymerization reaction is carried out after performing a polycondensation reaction, and if necessary, by adding a monomer with valency of three or higher as raw materials of a polycondensation resin to be a cross-linking agent to a reaction system after the addition polymerization reaction, the polycondensation is further performed at temperature conditions that are suitable for the polycondensation reaction.
(3) At temperature conditions that are suitable for an addition polymerization reaction, an addition polymerization reaction is performed in conjunction with a polycondensation reaction, and after the completion of the addition polymerization reaction, and if necessary, by adding a monomer with valency of three or higher as raw materials of a polycondensation resin to be a cross-linking agent to a reaction system, the polycondensation is further performed at temperature conditions that are suitable for the polycondensation reaction.

Because an addition polymerization resin (vinyl polymerization segment) and a polycondensation resin (polyester polymerization segment) bind to each other via a both reactive monomer in the aforementioned composite resin, the specific method for manufacturing the resin is as follows, for example: a both reactive monomer is used together with a monomer of raw materials for a polycondensation resin and/or a monomer of raw materials for an addition polymerization resin, and preferably with a monomer of raw materials for an addition polymerization resin, and at any time point which is before, during, or after the addition polymerization of a monomer of raw materials for an addition polymerization resin, a monomer of raw materials for a polycondensation resin is allowed to be present in a system for the addition polymerization reaction to have a polycondensation reaction.

For a case in which the vinyl polymer part and the polyester part do not bind to each other in the surface resin, the vinyl polymer part (vinyl resin) has glass transition point (Tg) of preferably 20 to 70° C., and more preferably 30 to 60° C.

In the present invention, the glass transition point (Tg) of the vinyl polymer part indicates a value which is measured by using “DIAMOND DSC” (manufactured by Perkin Elmer, Co., Ltd)

Measurement order is as follows, 3.0 mg of a measurement sample (vinyl resin) is sealed in an aluminum pan and set in a holder. An empty aluminum pan is used as a reference. Measurement conditions are as follows. The temperature is controlled through heating-cooling-heating at a temperature-increasing rate of 10° C./min and a temperature-lowering rate of 10° C./min in the measurement temperature of 0 to 200° C. Analysis is made based on the data from the second heating, and an extension line from the base-line prior to the rise of the first endothermic peak and a tangent line exhibiting the maximum slope between the initial rise and the peak of the first endothermic peak are drawn, and the intersection of both lines is defined as the glass transition point.

For a case in which the vinyl polymer part and the polyester part do not bind to each other in the surface resin, the vinyl polymer part (vinyl resin) preferably has molecular weight of 5,000 to 500,000, in terms of weight average molecular weight (Mw) as measured by gel permeation chromatography (GPC).

In the present invention, the molecular weight of the vinyl polymer part according to gel permeation chromatography (GPC) indicates a value which is measured as described below.

Specifically, the apparatus “HLC-8120GPC” (manufactured by TOSOH CORPORATION) and the column “TSK guard column+TSK gel Super HZ-M3 series” (manufactured by TOSOH CORPORATION) are used, tetrahydrofuran (THF) is added as a carrier solvent at a flow rate of 0.2 ml/min while maintaining the column temperature at 40° C., a measurement sample (vinyl resin) is dissolved in tetrahydrofuran to have concentration of 1 mg/ml under dissolving conditions including 5-minute treatment with an ultrasonic disperser at room temperature, a sample solution is obtained subsequently by treating with a membrane filter with pore size of 0.2 μm, 10 μL of the sample solution is injected to the device together with the carrier solvent, the detection is made by using a refractive index detector (RI detector), and molecular weight distribution of the measurement sample is calculated by using a calibration curve which is established by using mono-dispersed polystyrene reference particles. Ten points were used as the polystyrene for establishing a calibration curve.

For a case in which the vinyl polymer part and the polyester part do not bind to each other in the surface resin, the polyester polymer part (polyester resin) has glass transition point (Tg) of preferably 20 to 70° C., and more preferably 30 to 60° C.

Further, the polyester polymer part (polyester resin) preferably has molecular weight of 5,000 to 1,000,000, in terms of weight average molecular weight (Mw) as measured by gel permeation chromatography (GPC).

The glass transition point and molecular weight measured by gel permeation chromatography (GPC) of the polyester part are the values that are measured in the same manner as above except that a polyester resin is used as a measurement sample.

For a case in which the vinyl polymer part (vinyl polymerization segment) and the polyester part (polyester polymerization segment) bind to each other in the surface resin, the composite resin has glass transition point (Tg) of preferably 20 to 70° C., and more preferably 30 to 60° C.

Further, the composite resin preferably has molecular weight of 5,000 to 1,000,000, in terms of weight average molecular weight (Mw) as measured by gel permeation chromatography (GPC).

The glass transition point and molecular weight measured by gel permeation chromatography (GPC) of the composite resin have the values that are measured in the same manner as above except that a composite resin is used as a measurement sample.

In the present invention, the resin present on a surface of the toner particles is defined as a resin which is present within 300 nm from the surface of the toner particle to the center.

A state of the surface of the toner particles can be observed by a standard measurement in which a cross-section of the toner particle stained with ruthenium (VIII) oxide or osmium (VIII) oxide is observed by transmission electron microscopy (TEM).

### <Colorant>

For a case in which a colorant is contained in the toner particles, examples of the colorant include carbon black, a magnetic material, a dye, and a pigment.

Examples of the carbon black include channel black, furnace black, acetylene black, thermal black, and lamp black, or the like.

Examples of the magnetic material include a ferromagnetic metal such as iron, nickel, or cobalt, an alloy containing those metals, a compound of a ferromagnetic metal such as ferrite or magnetite, and an alloy which does not contain a ferromagnetic metal but exhibits a ferromagnetic property after heating treatment (for example, Heusler alloy such as manganese-copper-aluminum or manganese-copper-tin, and chromium dioxide).

Examples of the dye include C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, and C.I. Solvent Blue 95, or the like.

Examples of the pigment include C.I. Pigment Red 5, C.I. Pigment Red 48:1, C.I. Pigment Red 53:1, C.I. Pigment Red 57:1, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Orange 31, C.I. Pigment Orange 43, C.I. Pigment Blue 15:3, and C.I. Pigment Blue 60, or the like.

It can be used singly or in combination of two or more types.

Content of the colorant is preferably 4 to 10 parts by weight, and more preferably 5 to 8 parts by weight relative to 100 parts by weight of the binder resin.

### <Releasing Agent>

When a releasing agent is contained in the toner particles, examples of the releasing agent include hydrocarbon waxes such as a low molecular weight polyethylene wax, low molecular weight polypropylene wax, Fischer Tropsh wax, microcrystalline wax, and paraffin wax; and ester waxes such as Carnauba wax, pentaerythritol behenate ester, behenyl behenate and behenyl citrate. It can be used singly or in combination of two or more types.

The melting point of the releasing agent is preferably 50 to 95° C. from the viewpoint of the low temperature fixability and releasing property.

Content of the releasing agent is preferably 2 to 20% by weight, and more preferably 3 to 18% by weight in the total amount of the binder resin.

### <Charge Controlling Agent>

For a case in which a charge controlling agent is contained in the toner particles, various well-known charge controlling agents which can be also dispersed in an aqueous medium can be used. Specific examples thereof include a nigrosine dye, a metal salt of naphthenic acid or a higher fatty acid, an alkoxylated amine, a quaternary ammonium salt compound, an azo metal complex and a metal salt of salicylic acid or its metal complex. The charge controlling agent preferably has a number average primary particle diameter of 10 to 500 nm in a dispersed state.

### <External Additives>

The toner of the first embodiment includes external additives which contain metal salts of fatty acid. Further, for improvement of fluidity, electrification property, cleaning property, or the like, the external additives may include a so-called fluidizing agent, a cleaning aid, or the like in addition to the metal salts of fatty acid.

In the first embodiment, the metal salts of fatty acid have a function of a lubricating agent. Specifically, the metal salts of fatty acid supplied on top of a photoreceptor is spread on top of a photoreceptor by a cleaning means like a cleaning blade and, as a lubricating agent, the metal salts of fatty acid lowers friction between the cleaning blade and a photoreceptor surface, and thus it has a function of improving the property of cleaning residual toner spread on top of a photoreceptor (toner remained on top of a photoreceptor without being transferred onto a transfer medium).

From the viewpoint of the spreading property on a photoreceptor, metal salts of fatty acid with Mohs hardness of 2 or less are preferred as the metal salts of fatty acid. Preferred examples of the metal salts of fatty acid include a salt of metal selected from zinc, calcium, magnesium, aluminum, and lithium. Among them, from the viewpoint of enhancing the lubricating property, a salt of metal like zinc, lithium, or calcium is preferable. Further, as for the fatty acid of the metal salts of fatty acid, a higher fatty acid with carbon number of 12 to 22 is preferable. When a fatty acid with carbon number of 12 or higher is used, generation of free metal salts of fatty acid can be suppressed. When a fatty acid with carbon number of 22 or lower is used, the melting point of the metal salts of fatty acid does not increase excessively so that good fixability is obtained. Stearic acid is particularly preferred as the fatty acid. Taken together, zinc stearate, lithium stearate, and calcium stearate are particularly preferred as the metal salts of fatty acid.

The average particle diameter of the metal salts of fatty acid is, in terms of volume average particle diameter, preferably 0.3 μm to 20 μm, and more preferably 0.5 μm to 5 μm, still more preferably over 0.6 μm and less than 3.5 μm, and particularly preferably 0.65 μm to 3.4 μm.

When the average particle diameter of the metal salts of fatty acid is 0.3 μm or more, adhesion to the toner is obtained at a suitable level so that transfer with the toner without being supplied onto a photoreceptor can be suppressed. Further, when the average particle diameter of the metal salts of fatty acid is 20 μm or less, the photoreceptor can be surely given with the lubricating property.

The volume average particle diameter of the metal salts of fatty acid indicates the value which is measured by using a laser diffraction/scattering type particle size distribution analyzer “LA-750” (manufactured by HORIBA, Ltd.).

The addition amount of the metal salts of fatty acid is preferably 0.01 to 0.50 parts by weight and more preferably 0.015 to 0.30 parts by weight relative to 100 parts by weight of the toner particles.

When the addition amount of the metal salts of fatty acid is 0.01 parts by weight or more, the photoreceptor can be surely given with the lubricating property. Further, when the addition amount of the metal salts of fatty acid is 0.50 parts by weight or less, an increase in initial electrifying amount under a low temperature and low humidity environment can be surely suppressed.

Examples of the external additives that can be used in combination with the metal salts of fatty acid include inorganic microparticles such as metal oxide and organic microparticles such as a polymer including polystyrene, polymethyl methacrylate, and styrene-methyl methacrylate copolymer.

As for the metal oxide, well-known one in the art can be used, and examples thereof include silica, alumina, titania, zirconia, zinc oxide, chromium oxide, cerium oxide, antimony oxide, tungsten oxide, tin oxide, tellurium oxide, manganese oxide, and boron oxide.

Among them, silica, alumina, titanium and composite oxide thereof that are produced by a vapor phase method are particularly preferred. As for the composite oxide described herein, those containing at least one atom from titanium atom, aluminum atom, zirconium atom, and calcium atom in addition to silicon atom are preferred. Further, metatitanate, anatase type, rutile type, and amorphous titania that are produced by sulfuric acid method or the like can be also mentioned as a preferred example.

Surface of the external additives of inorganic microparticles that are described above are preferably treated with a well-known treating agent such as a coupling agent. Examples of the treating agent include a hydrophobizing treating agent and silicone oil.

Examples of the hydrophobizing treating agent include dimethyl dimethoxysilane, hexamethyl disilazane (HMDS), methyl trimethoxysilane, isobutyl trimethoxysilane, and decyl trimethoxysilane, or the like.

Examples of the silicone oil include an organosiloxane oligomer, a cyclic compound such as octamethylcyclotetrasiloxane, decamethylcyclopentanesiloxane, tetramethylcyclotetrasiloxane, and tetravinyltetramethylcyclotetrasiloxane, and a linear or branched organosiloxane. It is also possible to use silicone oil having at least modified terminal and high reactivity, that is, modifying group is introduced to a side chain, a single terminal, both terminals, a single terminal of a side chain, or both terminals of a side chain. Examples of the modifying group include alkoxy, carboxy, carbinol, modification with higher fatty acid, phenol, epoxy, methacryl, and amino. It may be also silicone oil having various kinds of a modifying group such as amino/alkoxy modification. It is also possible to perform a mixing treatment or a combination treatment with dimethyl silicone oil and those modified silicone oils, and also other surface treating agent. Examples of the treating agent which is used in combination include a silane coupling agent, a titanate-based coupling agent, an aluminate-based coupling agent, various silicone oils, fatty acids, metal salts of fatty acid, ester products thereof, and rosin acid.

The average particle diameter of the external additives of inorganic microparticles is preferably 5 nm to 300 nm.

The addition amount of the external additives is, in terms of their total amount, preferably 0.1 to 10% by weight, and more preferably 1.0 to 3.0% by weight relative to the entire toner particles.

### <Glass Transition Point of Toner>

The toner of the first embodiment has a glass transition point (Tg) of preferably 20 to 70° C., and more preferably 30 to 60° C.

When the toner of the first embodiment has a glass transition point within the aforementioned range, both the sufficient low temperature fixability and heat resistant storability can be surely obtained.

The glass transition point of the toner is measured in the same manner as above except that a toner is used as a measurement sample.

### [Particle Diameter of Toner]

The average particle diameter of the toner of the first embodiment is preferably 4 to 10 μm in terms of a volume-based median diameter. The average particle diameter can be controlled based on concentration of an aggregating agent or addition amount of an organic solvent used for manufacture, time for fusion, composition of a binder resin, or the like.

When the volume-based median diameter falls within the foregoing range, a minute dot image, for example, at a level of 1200 dpi can be faithfully reproduced.

The volume-based median diameter of the toner is measured and calculated by “Multisizer 3” (manufactured by Beckman Coulter, Inc.) connected to a computer system equipped with “Software V3.51”, which is a software for data processing. Specifically, 0.02 g of a measurement sample (toner) is added to a 20 ml surfactant solution (in which, for example, a neutral detergent containing a surfactant component is diluted 10 times with pure water for the purpose of dispersing toner particles) followed by fusion, and then subjected to ultrasonic dispersion for 1 minute to prepare the toner dispersion. The toner dispersion is introduced by a pipette into a beaker containing ISOTON II (manufactured by Beckman Coulter, Inc.) placed in a sample stand until it reaches a display concentration of 8% by the device for measurement. Such a concentration range makes it possible to obtain reproducible measurement values. Further, with regard to the device for measurement, the counting number for particles for measurement is set to 25000 particles and an aperture diameter of 100 μm is used. A measurement range of 2 to 60 μm is divided to 256 parts and the frequency of an individual part is calculated and the particle diameter at 50% of volume fraction integrated from the larger side is defined as the volume-based median diameter.

### [Average Circularity of Toner]

With regard to the toner of the first embodiment, the average circularity of each individual toner particle which constitutes the toner is preferably 0.850 to 0.990, from the viewpoint of stability of the electrification property and low temperature fixability.

When the average circularity falls within the aforementioned range, it is difficult for each individual toner particle to be broken, and thus contamination of a member for having frictional electrification is suppressed. Accordingly, the electrification property of the toner is stabilized and high image quality is obtained for an image to be formed.

The average circularity of the toner is a value measured by using “FPIA-2100” (manufactured by Sysmex Corporation). Specifically, a measurement sample (toner) is fused in an aqueous solution added with a surfactant and dispersed for 1 minute by an ultrasonic dispersion treatment. Using “FPIA-2100” (manufactured by Sysmex Corporation), the measurement condition is set to a high power field (HPF) mode and the image is taken at an optimum concentration including the HPF detection number of 3,000 to 10,000. The circularity is calculated for each toner particle according to the following formula (y), and the added circularity of each toner particle is divided by the total number of the toner particles. When the HPF detection number falls within the aforementioned range, the reproducibility is obtained.

Circularity=(Circumference length of a circle having an equivalent projection area of a particle image)/(circumference length of a projection image of a particle) Formula (y):

### <Method for Manufacturing Toner>

The method for manufacturing the toner of the first embodiment includes, for example, a suspension polymerization method, an emulsion aggregation method and other well-known methods.

Among them, the emulsion aggregation method is preferably employed from the viewpoint of having a homogeneity of particle diameter which is advantageous for having high image quality and high stability, shape controllability, and easiness for forming a core-shell structure.

According to the emulsion aggregation method, a dispersion of microparticles of a binder resin (hereinafter, also referred to as “resin microparticles”) produced by an emulsion polymerization is optionally mixed with a dispersion of components for constituting toner particles like microparticles of a colorant (hereinafter, also referred to as “colorant microparticles”), and then, those microparticles are allowed to aggregate by adding an aggregating agent until desired diameter of a toner particle is obtained and fusion between resin microparticles is further performed thereafter or simultaneously with the aggregation followed by performing the shape control, whereby a toner is manufactured.

Herein, the resin microparticles may optionally contain internal additives such as a releasing agent or a charge controlling agent or the resin microparticles can be composite particles that are formed by multi-layers with a constitution of two or more layers including a resin with different composition.

The resin microparticles can be manufactured by an emulsion polymerization method, a mini emulsion polymerization method, a reverse phase emulsion method, or a combination of several methods. When internal additives are included in resin microparticles, it is preferable to use a mini emulsion polymerization method among them.

An example of a case in which an emulsion aggregation method is employed as a method for manufacturing a toner is described below.
(1) Step for preparing a dispersion which includes colorant microparticles dispersed in an aqueous medium,
(2) Step for preparing a dispersion which includes resin microparticles dispersed in an aqueous medium, in which the microparticles are optionally added with internal additives,
(3) Step for mixing the dispersion of colorant microparticles and the dispersion of resin microparticles and allowing the colorant microparticles and the resin microparticles to aggregate and fuse to form toner particles,
(4) Step for filtering off the toner particles from a toner particle dispersion (aqueous medium) to remove a surfactant or the like,
(5) Step for drying the toner particles, and
(6) Step for adding external additives to the toner particles.

As described herein, the aqueous medium indicates a medium of which main component (50% by weight or more) includes water. Examples of the component other than water include an organic solvent which is dissolved in water, and examples thereof include methanol, ethanol, isopropanol, butanol, acetone, methyl ethyl ketone, and tetrahydrofuran. Among them, an alcoholic organic solvent such as methanol, ethanol, isopropanol, and butanol, which is an organic solvent not dissolving the resin, is particularly preferable.

With regard to the toner of the first embodiment, when the toner particles have a core-shell structure, resin microparticles used for core particles and colorant microparticles are subjected to aggregation and fusion to produce core particles, and subsequently, resin microparticles used for a shell are added to the dispersion of the core particles and subjected to aggregation and fusion on the surfaces of the core particles, whereby toner particles of a core/shell structure in which a shell layer is coated on the core particle surface can be obtained.

### [Surfactant]

The aqueous medium may contain a surfactant, and as for the surfactant, well-known in the art various anionic surfactants, cationic surfactants, non-ionic surfactants, or the like can be used.

### [Aggregating Agent]

An aggregating agent which is used in the step of aggregation and fusion is not specifically limited but one selected from metal salts such as alkali metal salts or alkali earth metal salts is preferably used. Examples of such metal salts include a salt of a monovalent metal such as sodium, potassium or lithium; a salt of a divalent metal such as calcium, magnesium, manganese or copper; and a salt of a trivalent metal such as iron or aluminum. Specific examples of a metal salt include sodium chloride, potassium chloride, lithium chloride, calcium chloride, manganese chloride, zinc chloride, copper sulfate, magnesium sulfate and manganese sulfate. Of these metal salts, a divalent metal salt is particularly preferably used from the viewpoint of having the aggregation with a smaller amount. It can be used singly or in combination of two or more types.

### [Method for Adding External Additives]

As a method for adding external additives, a mixing treatment with extended mixing time and/or increased revolution rate of stirring wings is performed by using a mixing device such as Henschel mixer which can give shear force to particles for treatment. Further, when a plurality of external additives is used, all the external additives can be mixed and treated simultaneously or can be divided and subjected to mixing treatment in several times. Examples of the mixing device include a mechanical mixing device such as a Henschel mixer or a coffee mill.

### <Two-Component Developer>

The two-component developer of the second embodiment is obtained by mixing the toner of the first embodiment with a carrier for electrostatic charge image development (hereinbelow, it is also simply referred to as a “carrier”).

Examples of the carrier which may be used include magnetic particles including well-known materials in the art, for example, a metal such as iron, ferrite or magnetite, an alloy of the foregoing metal and a metal of aluminum or lead. Of these, ferrite particles are preferred in particular. There may be also used a coated carrier in which the surfaces of magnetic particles are coated with a coating agent such as a resin. It is also possible to use a resin dispersion type carrier in which a fine powdery magnetic material is dispersed in a binder resin.

The average particle diameter of the carrier is preferably 20 to 100 μm, and more preferably 25 to 80 μm in terms of volume-based median diameter.

The volume-based median diameter of the carrier can be measured by a laser diffraction particle distribution analyzer “HELOS” (manufactured by SYMPATEC, GmbH.) equipped with a wet disperser, for example.

As the toner of the first embodiment is contained in the aforementioned two-component developer, a decrease in image density as caused by excessive electrification under a low temperature and low humidity environment can be suppressed, fogging as caused by decreased electrification under a high temperature and high humidity environment can be prevented, and a difference in image density can be suppressed. Accordingly, an image with high quality can be stably obtained.

### <Method for Forming an Image>

The method for forming an image of the third embodiment is characterized in that it has a step of electrifying a surface of a photoreceptor by an electrifying roller that is installed to be in contact with a photoreceptor, using the two-component developer including the toner of the first embodiment and a carrier.

Specifically, the method for forming an image of the third embodiment has the following steps.
(a) A step of electrifying a surface of a photoreceptor by an electrifying roller which is installed to be in contact with a photoreceptor.
(b) A step of forming an electrostatic latent image by light exposure on a photoreceptor.
(c) A step of developing the electrostatic latent image formed on a photoreceptor with a two-component developer for forming a toner image.
(d) A step of transferring the toner image formed on a photoreceptor onto an image support.
(e) A step of fixing the toner image transferred onto an image support.
(f) A step of removing a transfer residual toner on a photoreceptor by a cleaning blade.

According to the method for forming an image described above, because the two-component developer of the second embodiment is used, a decrease in image density as caused by excessive electrification under a low temperature and low humidity environment can be suppressed, fogging as caused by decreased electrification under a high temperature and high humidity environment can be prevented, and a difference in image density can be suppressed even when an electrification mode using an electrifying roller is employed, and thus an image with high quality can be stably obtained.

### EXAMPLES

Hereinbelow, specific examples of the present invention are described but the present invention is not limited to them.

### [Preparation of Colorant Microparticle Dispersion]

In 1600 parts by weight of ion exchange water, 90 parts by weight of sodium dodecyl sulfate was dissolved under stirring to produce a solution, and then 420 parts by weight of carbon black “MOGUL L” was gradually added to the solution. Subsequently, a dispersion treatment was performed by using a stirring device “CREAMIX” (manufactured by M Technique Co., Ltd.) to prepare a “colorant microparticle dispersion [1]”. The particle diameter of the colorant microparticle in the colorant microparticle dispersion [1] was measured by using a micro-track particle size distribution analyzer “UPA-150” (manufactured by Nikkiso Co., Ltd.), and as a result, the particle diameter was found to be 117 nm.

### [Preparation of Resin Microparticle Dispersion [A1]]

### (1) First Stage Polymerization

To a reaction vessel equipped with a stirrer, a temperature sensor, a temperature controller, a condenser, and a device for introducing nitrogen, an anionic surfactant solution in which 2.0 parts by weight of an anionic surfactant of sodium lauryl sulfate is dissolved in 2,900 parts by weight of ion exchange water was added, and the internal temperature was raised to 80° C., while stirring at 230 rpm under a nitrogen stream.

To the surfactant solution, 9.0 parts by weight of a polymerization initiator “potassium persulfate: KPS” were added, and after adjusting the internal temperature to 78° C., a solution (1) including 540 parts by weight of styrene, 270 parts by weight of n-butyl acrylate, 65 parts by weight of methacrylic acid, and 17 parts by weight of n-octyl mercaptan was added dropwise thereto over 3 hours. When the dropwise addition is completed, heating and stirring was carried out at 78° C. for 1 hour to perform polymerization (first stage polymerization). Accordingly, the “dispersion of resin microparticles [a1]” was prepared.

### (2) Second Stage Polymerization

To a solution (2) including 94 parts by weight of styrene, 60 parts by weight of n-butyl acrylate, 11 parts by weight of methacrylic acid, and 5 parts by weight of n-octyl mercaptan in a flask equipped with a stirring device, 55 parts by weight of paraffin wax (melting point: 73° C.) was added as a releasing agent and dissolved with heating at 85° C. to prepare a monomer solution.

Meanwhile, a surfactant solution in which 2 parts by weight of an anionic surfactant, “sodium lauryl sulfate” was dissolved in 1100 parts by weight of ion exchange water was heated to 90° C. To the surfactant solution, the “resin microparticle dispersion [a1]” was added in an amount of 28 parts by weight in terms of solid of the resin microparticles [a1]. Then, the foregoing monomer solution was mixed and dispersed therein by using a mechanical disperser provided with a circulation path (CREAMIX, manufactured by M Technique Co., Ltd.) over 4 hours to prepare a dispersion containing emulsified particles having a dispersion particle diameter of 350 nm. To this dispersion, an initiator solution in which 2.5 parts by weight of a polymerization initiator “KPS” is dissolved in 110 parts by weight of ion exchange water was added and the mixture was heated at 90° C. by stirring and heating the system for 2 hours to perform polymerization (second stage polymerization), whereby a “dispersion of resin microparticles [all]” was obtained.

### (3) Third Stage Polymerization

To the “dispersion of resin microparticles [all]”, an initiator solution in which 2.5 parts by weight of “KPS” as of a polymerization initiator is dissolved in 110 parts by weight of ion exchange water was added and a solution (3) containing 230 parts by weight of styrene, 100 parts by weight of n-butyl acrylate, and 5.2 parts by weight of n-octyl mercaptan was added dropwise thereto over 1 hour at temperature condition of 80° C. When the dropwise addition is completed, heating and stirring was carried out for 3 hours to perform polymerization (third stage polymerization). After that, cooling to 28° C. was performed, and thus the resin microparticle dispersion [A1] including a vinyl resin, which is a styrene-acrylic copolymer resin, was prepared. The glass transition point of the vinyl resin included in the obtained resin microparticle dispersion [A1] is 49° C., and the weight average molecular weight of these is 45,000.

### [Preparation of Resin Microparticle Dispersion [B1]]

### (1) Synthesis of Polyester Resin

To a 10 liter four-necked flask equipped with an inlet for nitrogen, a dehydration tube, a stirrer, and a thermocouple, 500 parts by weight of bisphenol A propylene oxide 2 mol adduct, 117 parts by weight of terephthalic acid, 82 parts by weight of fumaric acid, and 2 parts by weight of an esterification catalyst (tin octylate) were added and subjected to condensation polymerization for 8 hours at 230° C. By performing the reaction again for 2 hours at 2 kPa followed by cooling to 160° C., the polyester resin [b1] was obtained. The glass transition point of the obtained polyester resin [b1] is 54° C., and the weight average molecular weight of these is 20,000.

### (2) Preparation of Resin Microparticle Dispersion

100 parts by weight of the polyester resin [b1] were dissolved in 400 parts by weight of ethyl acetate. Subsequently, by adding 25 parts by weight of 5.0% by weight aqueous solution of sodium hydroxide, a resin solution was prepared. The resin solution was added to a vessel equipped with a stirring device and added dropwise with 638 parts by weight of 0.26% by weight aqueous solution of sodium lauryl sulfate over 30 minutes while stirring the resin solution. During the dropwise addition of an aqueous solution of sodium lauryl sulfate, the liquid inside the reaction vessel turned cloudy. Further, after adding dropwise the entire amount of an aqueous solution of sodium lauryl sulfate, an emulsion in which the resin solution particles are homogeneously dispersed was prepared.

Subsequently, the emulsion was heated to 40° C., and by distilling off the ethyl acetate under reduced pressure of 150 hPa using a diaphragm type vacuum pump “V-700” (manufactured by BUCHI), the “resin microparticle dispersion [B1]” including a polyester resin was prepared.

[Preparation of resin microparticle dispersion [C1]]

### (1) Synthesis of Composite Resin

To a 10 liter four-necked flask equipped with an inlet for nitrogen, a dehydration tube, a stirrer, and a thermocouple, 500 parts by weight of bisphenol A propylene oxide 2 mol adduct, 117 parts by weight of terephthalic acid, 82 parts by weight of fumaric acid, and 2 parts by weight of an esterification catalyst (tin octylate) were added and subjected to condensation polymerization for 8 hours at 230° C. After performing the reaction again for 2 hours at 2 kPa followed by cooling to 160° C., a mixture containing 10 parts by weight of acrylic acid, 162 parts by weight of styrene, 42 parts by weight of n-butyl acrylate, and 10 parts by weight of a polymerization initiator (di-t-butyl peroxide) was added over 1 hour by using a dropping funnel. After the dropwise addition, the addition polymerization reaction was continued for 1 hour while maintaining at 160° C. Then, the temperature was raised to 200° C. and it was maintained for 1 hour at 10 kPa. Thereafter, by removing the acrylic acid, styrene, and butyl acrylate, the composite resin [c1] including a vinyl polymerization segment and a polyester polymerization segment that are bound to each other was synthesized. The glass transition point of the obtained composite resin is 55° C., and the weight average molecular weight of these is 25,000. The ratio of the vinyl polymerization segment of the obtained composite resin is 23% by weight, relative to the total weight of a vinyl polymerization segment and a polyester polymerization segment.

### (2) Preparation of Resin Microparticle Dispersion

100 parts by weight of the composite resin [c1] were dissolved in 400 parts by weight of ethyl acetate. Subsequently, by adding 25 parts by weight of 5.0% by weight aqueous solution of sodium hydroxide, a resin solution was prepared. The resin solution was added to a vessel equipped with a stirring device and added dropwise with 638 parts by weight of 0.26% by weight aqueous solution of sodium lauryl sulfate over 30 minutes while stirring the resin solution. During the dropwise addition of an aqueous solution of sodium lauryl sulfate, the liquid inside the reaction vessel turned cloudy. Further, after adding dropwise the entire amount of an aqueous solution of sodium lauryl sulfate, an emulsion in which the resin solution particles are homogeneously dispersed was prepared.

Subsequently, the emulsion was heated to 40° C., and by distilling off the ethyl acetate under reduced pressure of 150 hPa using a diaphragm type vacuum pump “V-700” (manufactured by BUCHI), the “resin microparticle dispersion [C1]” including a composite resin was prepared.

### [Production of Metal Salts of Fatty Acid [1]]

140 parts by weight of stearic acid were added to 1000 parts by weight of ethanol and mixed at 75° C., followed by slow addition of 50 parts by weight of zinc hydroxide and mixing for 1 hour. After that, it was cooled to 20° C., and the product was collected and dried at 150° C. to remove ethanol. The solid matter of the obtained zinc stearate was coarsely crushed with a hammer mill followed by fine crushing with a jet stream type crusher “1-20 jet mill” (manufactured by Nippon Pneumatic Mfg. Co., Ltd.). Further, according to classification to cut point of 1.9 μm by using “DS-20/DS-10 wind-type classifier” (manufactured by Nippon Pneumatic Mfg. Co., Ltd.), the metal salts of fatty acid [1] including zinc stearate with volume average particle diameter of 1.5 μm were produced.

### [Production of Metal Salts of Fatty Acid [2]]

The metal salts of fatty acid [2] including zinc stearate with volume average particle diameter of 0.7 μm were produced in the same manner as the production of the metal salts of fatty acid [1] except that the cut point is changed from 1.9 μm to 1.1 μm.

### [Production of Metal Salts of Fatty Acid [3]]

The metal salts of fatty acid [3] including zinc stearate with volume average particle diameter of 3.0 μm were produced in the same manner as the production of the metal salts of fatty acid [1] except that the cut point is changed from 1.9 μm to 3.4 μm.

### [Production of Metal Salts of Fatty Acid [4]]

The metal salts of fatty acid [4] including zinc stearate with volume average particle diameter of 0.6 μm were produced in the same manner as the production of the metal salts of fatty acid [1] except that the cut point is changed from 1.9 μm to 1.0 μm.

### [Production of Metal Salts of Fatty Acid [5]]

The metal salts of fatty acid [5] including zinc stearate with volume average particle diameter of 3.5 μm were produced in the same manner as the production of the metal salts of fatty acid [1] except that the cut point is changed from 1.9 μm to 4.1 μm.

### [Production of Metal Salts of Fatty Acid [6]]

The metal salts of fatty acid [6] including lithium stearate with volume average particle diameter of 1.5 μm were produced in the same manner as the production of the metal salts of fatty acid [1] except that zinc hydroxide is changed to lithium hydroxide.

### [Production of Metal Salts of Fatty Acid [7]]

The metal salts of fatty acid [7] including calcium stearate with volume average particle diameter of 1.5 μm were produced in the same manner as the production of the metal salts of fatty acid [1] except that zinc hydroxide is changed to calcium hydroxide.

### Manufacture of Toner [1]

### Example 1

### (1) Aggregation • Fusion Step

To a reaction vessel equipped with a stirrer, a temperature sensor, and a condenser, the “resin microparticle dispersion [A1] ” was added in an amount of 328 parts by weight in terms of solid matter and also ion exchange water was added in an amount of 2000 parts by weight. Then, the pH at 25° C. was adjusted to 10 by adding an aqueous 5 mol/L sodium hydroxide solution.

Subsequently, an aqueous solution in which 60 parts by weight of magnesium chloride is dissolved in 60 parts by weight of ion exchange water was added thereto over 10 minutes at 30° C. under stirring. After the mixture was allowed to stand for 3 minutes, the temperature was raised to 80° C. over 60 minutes and particle growth was continued, while maintaining the temperature at 80° C. In the same state, the particle diameter of aggregated particles was measured by “Coulter Multisizer 3” (manufactured by Beckman Coulter, Inc.). When the volume-based median diameter (D₅₀) of aggregated particles reached 4.0 μm, the “resin microparticle dispersion [B1]” was added over 30 minutes in an amount of 72 parts by weight in terms of solid matter. When the supernatant of the reaction liquid became clear and the volume-based median diameter (D₅₀) of aggregated particles reached 6.3 μm, an aqueous solution in which 190 parts by weight of sodium chloride is dissolved in 760 parts by weight of ion exchange water was added thereto to terminate the particle growth.

The temperature was further raised to 90° C. and heating and stirring was conducted to allow the fusion of the particles to proceed and when the average circularity of toner particles reached 0.945 as determined by using an instrument, “FPIA-2100” (manufactured by Sysmex Corp.) (HPF detection number; 4000), it was cooled to 30° C. to prepare the “toner particle dispersion [1]”.

The particles of the obtained toner particle dispersion [1] were stained with ruthenium (VIII) oxide, and were observed by transmission electron microscopy (TEM) for image analysis. In image analysis, the surface was defined as the surface which is within 300 nm from the surface layer, each areas of the vinyl polymer part and the polyester part within 300 nm from the surface layer were measured, and the weight ratio between the vinyl resin and the polyester resin was 20/80, which obtained by calculation.

### (2) Washing Step and Drying Step

The obtained toner particle dispersion [1] was subjected to solid/liquid separation by using a centrifuge to form a wet cake of the toner particles. The wet cake was washed with 35° C. ion exchange water by centrifugal separation until the electric conductivity of the filtrate becomes 5 μS/cm. After that, it was transferred to “Flush Jet Dryer” (manufactured by Seishin Kigyo Co., Ltd.) and dried until the moisture content reaches 0.5% by weight.

### (3) Step for Adding External Additives

To 100 parts by weight of the toner particles obtained after the drying treatment, 0.75 parts by weight of small-diameter silica microparticles (“RX-200”, fumed silica, treated with HMDS, number average particle diameter of 12 nm; manufactured by Nippon Aerosil Co., Ltd.), 1.50 parts by weight of spherical silica microparticles “X-24 9600”, silica obtained by sol-gel method, treated with HMDS, number average particle diameter of 80 nm; manufactured by Shin-Etsu Chemical Co., Ltd.), and 0.5 parts by weight of calcium titanate as metal oxide microparticles having high polishing effect (“TC110”, number average particle diameter of 300 nm, treated with silicone oil; manufactured by Titan Kogyo, Ltd.) were added and mixed for 12 minutes by using Henschel mixer “FM10B” (manufactured by Mitsui Miike Seisakusho, K.K.) at stirring wing speed of 40 m/sec and treatment temperature of 30° C. Subsequently, the metal salts of fatty acid [1] were added thereto in an amount of 0.15 parts by weight, and mixed for 8 minutes at treatment temperature of 30° C. and stirring wing speed of 40 m/sec. After that, the coarse particles were removed by using a sieve with mesh size of 90 μm to obtain the toner [1]. According to the toner [1], the liberation ratio of the metal salts of fatty acid was 55% and the number average particle diameter of the particles that are present in the supernatant was 1.5 μm.

Meanwhile, as a result of observing the cross-section of the toner particles of the toner [1] which stains with ruthenium (VIII) oxide under a transmission electron microscope (TEM), it was found that the shell layer of the polyester resin (resin microparticles [B1]) does not completely cover the core of the styrene-acrylic copolymer resin (resin microparticles [A1]), and thus the core is exposed. As such, in the toner [1], both the vinyl polymer part and the polyester part were confirmed to be present on a surface of the toner particles.

### Manufacture of Toner [2]

### Example 2

### (1) Aggregation • Fusion Step

To a reaction vessel equipped with a stirrer, a temperature sensor, and a condenser, the “resin microparticle dispersion [A1] ” was added in an amount of 328 parts by weight in terms of solid matter and also ion exchange water was added in an amount of 2000 parts by weight. Then, the pH at 25° C. was adjusted to 10 by adding an aqueous 5 mol/L sodium hydroxide solution.

Subsequently, an aqueous solution in which 60 parts by weight of magnesium chloride is dissolved in 60 parts by weight of ion exchange water was added thereto over 10 minutes at 30° C. under stirring. After the mixture was allowed to stand for 3 minutes, the temperature was raised to 80° C. over 60 minutes and particle growth was continued, while maintaining the temperature at 80° C. In the same state, the particle diameter of aggregated particles was measured by “Coulter Multisizer 3” (manufactured by Beckman Coulter, Inc.). When the volume-based median diameter (D₅₀) of aggregated particles reached 6.0 μm, aqueous solution in which 95 parts by weight of sodium chloride is dissolved in 380 parts by weight of ion exchange water was added thereto to terminate the particle growth. And then, the “resin microparticle dispersion [C1]” was added thereto over 30 minutes in an amount of 72 parts by weight in terms of solid matter. When the supernatant of the reaction liquid became clear, an aqueous solution in which 190 parts by weight of sodium chloride is dissolved in 760 parts by weight of ion exchange water was added thereto to terminate the particle growth.

The temperature was further raised to 90° C. and heating and stirring was conducted to allow the fusion of the particles to proceed and when the average circularity of toner particles reached 0.945 as determined by using an instrument, “FPIA-2100” (manufactured by Sysmex Corp.) (HPF detection number; 4000), it was cooled to 30° C. to prepare the “toner particle dispersion [2]”.

### (2) Washing Step and Drying Step

The obtained toner particle dispersion [2] was subjected to solid/liquid separation by using a centrifuge to form a wet cake of the toner particles. The wet cake was washed with 35° C. ion exchange water by centrifugal separation until the electric conductivity of the filtrate becomes 5 μS/cm. After that, it was transferred to “Flush Jet Dryer” (manufactured by Seishin Kigyo Co., Ltd.) and dried until the moisture content reaches 0.5% by weight.

### (3) Step for Adding External Additives

To 100 parts by weight of the toner particles obtained after the drying treatment, 0.75 parts by weight of small-diameter silica microparticles (“RX-200”, fumed silica, treated with HMDS, number average particle diameter of 12 nm; manufactured by Nippon Aerosil Co., Ltd.), 1.50 parts by weight of spherical silica microparticles “X-24 9600”, silica obtained by sol-gel method, treated with HMDS, number average particle diameter of 80 nm; manufactured by Shin-Etsu Chemical Co., Ltd.), and 0.5 parts by weight of calcium titanate as metal oxide microparticles having high polishing effect (“TC110”, number average particle diameter of 300 nm, treated with silicone oil; manufactured by Titan Kogyo, Ltd.) were added and mixed for 12 minutes by using Henschel mixer “FM10B” (manufactured by Mitsui Miike Seisakusho, K.K.) at stirring wing speed of 40 m/sec and treatment temperature of 30° C. Subsequently, the metal salts of fatty acid [1] were added thereto in an amount of 0.15 parts by weight, and mixed for 8 minutes at treatment temperature of 30° C. and stirring wing speed of 40 m/sec. After that, the coarse particles were removed by using a sieve with mesh size of 90 μm to obtain the toner [2]. According to the toner [2], the liberation ratio of the metal salts of fatty acid was 55% and the number average particle diameter of the particles that are present in the supernatant was 1.5 μm.

### Manufacture of Toner [3] to [16]

### Examples 3 to 12 and Comparative Examples 1 to 4

The toners [3] to [16] were obtained in the same manner as the toner [2] except that the formulation of Table 1 is used. The liberation ratio of the metal salts of fatty acid in the obtained toner and the number average particle diameter of the particles that are present in the supernatant are given in Table 1.

### Manufacture of Toner [17]

### Comparative Example 5

The toner [17] was obtained in the same manner as the toner [2] except that the “resin microparticle dispersion [C1]” is changed to the “resin microparticle dispersion [B1]”. According to the toner [17], the liberation ratio of the metal salts of fatty acid was 55% and the number average particle diameter of the particles that are present in the supernatant was 1.5 μm.

TABLE 1

| | | Toner particles | Metal salts of fatty acid | | Time for mixing external | | | |
|---|---|---|---|---|---|---|---|---|
| | | Surface resin | | Addition | additives | | | Supernatant |
| | | (Resin micro- | | amount | Other | Metal salts | | particle |
| | | particle dis- | | (parts by | external | of fatty | Liberation | diameter |
| | Toner No. | persion No.) | No. | weight) | additives | acid | ratio (%) | (μm) |
| Example 1 | [1] | [A1]/[B1] | [1] | 0.15 | For 12 | For 8 | 55 | 1.5 |
| | | | | | minutes | minutes | | |
| Example 2 | [2] | [C1] | [1] | 0.15 | For 12 | For 8 | 55 | 1.5 |
| | | | | | minutes | minutes | | |
| Example 3 | [3] | [C1] | [6] | 0.15 | For 12 | For 8 | 55 | 1.5 |
| | | | | | minutes | minutes | | |
| Example 4 | [4] | [C1] | [7] | 0.15 | For 12 | For 8 | 55 | 1.5 |
| | | | | | minutes | minutes | | |
| Example 5 | [5] | [C1] | [1] | 0.01 | For 12 | For 8 | 55 | 1.5 |
| | | | | | minutes | minutes | | |
| Example 6 | [6] | [C1] | [1] | 0.015 | For 12 | For 8 | 55 | 1.5 |
| | | | | | minutes | minutes | | |
| Example 7 | [7] | [C1] | [1] | 0.3 | For 12 | For 8 | 55 | 1.5 |
| | | | | | minutes | minutes | | |
| Example 8 | [8] | [C1] | [1] | 0.35 | For 12 | For 8 | 55 | 1.5 |
| | | | | | minutes | minutes | | |
| Example 9 | [9] | [C1] | [1] | 0.15 | For 7 | For 13 | 30 | 1.5 |
| | | | | | minutes | minutes | | |
| Example 10 | [10] | [C1] | [1] | 0.15 | For 17 | For 3 | 80 | 1.5 |
| | | | | | minutes | minutes | | |
| Comparative | [11] | [C1] | [1] | 0.15 | For 6 | For 14 | 25 | 1.5 |
| Example 1 | | | | | minutes | minutes | | |
| Comparative | [12] | [C1] | [1] | 0.15 | For 18 | For 2 | 85 | 1.5 |
| Example 2 | | | | | minutes | minutes | | |
| Example 11 | [13] | [C1] | [2] | 0.15 | For 12 | For 8 | 55 | 0.7 |
| | | | | | minutes | minutes | | |
| Example 12 | [14] | [C1] | [3] | 0.15 | For 12 | For 8 | 55 | 3.0 |
| | | | | | minutes | minutes | | |
| Comparative | [15] | [C1] | [4] | 0.15 | For 12 | For 8 | 55 | 0.6 |
| Example 3 | | | | | minutes | minutes | | |
| Comparative | [16] | [C1] | [5] | 0.15 | For 12 | For 8 | 55 | 3.5 |
| Example 4 | | | | | minutes | minutes | | |
| Comparative | [17] | [B1] | [1] | 0.15 | For 12 | For 8 | 55 | 1.5 |
| Example 5 | | | | | minutes | minutes | | |

### <Production of Two-Component Developer [1]>

Ferrite carrier having volume-based median diameter of 33 μm, which is coated with a copolymerization resin of cyclohexyl methacrylate and methyl methacrylate (monomer ratio of 1:1), was admixed with the toner [1] to have the toner concentration of 6.0% by weight. As a result, the two-component developer [1] was produced.

### <Production of Two-Component Developer [2] to [17]>

The two-component developers [2] to [17] were produced in the same manner as the production of the two-component developer [1] except that the toner [1] is changed to each of the toner [2] to [17].

### <<Evaluation>>

As an apparatus for evaluating the two-component developer, the commercially available copying machine “BIZHUB C 454” (manufactured by Konica Minolta, Inc.) was used. After loading the developer which is produced from above in an order, the following evaluation was performed. The results are shown in Table 2.

### (Evaluation of Fogging)

After printing 500,000 copies of a letter image with printing ratio of 5% under a high temperature and high humidity condition (30° C.·80% RH), a white paper was printed and the evaluation was made based on the white paper density of the transfer material after printing of 500,000 copies. The density was measured at 20 areas on the transfer material of A4 size, and the average of the measured density was used as the white paper density. The density measurement was performed by using a reflection density analyzer “RD-918” (manufactured by Macbeth Co., Ltd.). When the white paper density was 0.01 or less, it was graded as “pass”.

### (Evaluation of Maximum Density)

The maximum density was evaluated as follows. After printing a black solid image on an A4 size transfer material under a low temperature and low humidity condition (10° C.·10% RH), the initial black solid image was evaluated in the same manner as the fogging density by using a reflection density analyzer “RD-918” (manufactured by Macbeth Co., Ltd.) based on the relative reflection density while the white paper density is used as a reference. When each density of the black solid image part was 1.2 or higher, it was graded as “pass”.

### (Density Unevenness Caused by Lubricating Agent)

The density unevenness caused by lubricating agent was evaluated as follows. After continuously printing 100 copies of a band image present on 20% of the total surface of an A4 size transfer material under a high temperature and high humidity condition (30° C.·80% RH), the reflection density from the band part and the background part of the 100th image was measured by using a reflection density analyzer “RD-907” (manufactured by Macbeth Co., Ltd.), and the evaluation was made based on a difference in the density. When a difference in the density was 0.05 or less, it was graded as “pass”.

TABLE 2

| | Two-component | | Maximum | Density |
|---|---|---|---|---|
| | developer No. | Fogging | density | unevenness |
| Example 1 | [1] | 0.003 | 1.27 | 0.02 |
| Example 2 | [2] | 0.005 | 1.4 | 0.02 |
| Example 3 | [3] | 0.006 | 1.38 | 0.02 |
| Example 4 | [4] | 0.006 | 1.35 | 0.02 |
| Example 5 | [5] | 0.008 | 1.42 | 0.01 |
| Example 6 | [6] | 0.006 | 1.44 | 0.03 |
| Example 7 | [7] | 0.002 | 1.33 | 0.04 |
| Example 8 | [8] | 0.001 | 1.29 | 0.01 |
| Example 9 | [9] | 0.007 | 1.42 | 0.04 |
| Example 10 | [10] | 0.002 | 1.31 | 0.05 |
| Comparative | [11] | 0.008 | 1.44 | 0.06 |
| Example 1 | | | | |
| Comparative | [12] | 0.001 | 1.29 | 0.07 |
| Example 2 | | | | |
| Example 11 | [13] | 0.002 | 1.22 | 0.04 |
| Example 12 | [14] | 0.008 | 1.48 | 0.04 |
| Comparative | [15] | 0.001 | 1.18 | 0.04 |
| Example 3 | | | | |
| Comparative | [16] | 0.012 | 1.5 | 0.04 |
| Example 4 | | | | |
| Comparative | [17] | 0.003 | 1.17 | 0.02 |
| Example 5 | | | | |

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

This application is based on the Japanese Patent Application No. 2014-014130 filed on Jan. 29, 2014, the entire content of which is herein incorporated by reference.

1. A toner for electrostatic charge image development which comprises toner particles containing at least a binder resin and external additives containing metal salts of fatty acid, wherein
a ratio of the metal salts of fatty acid that are liberated by a centrifugal treatment in an aqueous dispersion is 30 to 80% and the number average particle diameter of the particles that are present in a supernatant after the centrifugal treatment is 0.7 μm to 3.0 μm, the ratio and the number average particle diameter of the particles being measured by the centrifugation of the aqueous dispersion of the toner, and
the binder resin present on a surface of the toner particles contains a vinyl polymer part and a polyester part.

2. The toner for electrostatic charge image development according to claim 1, wherein the vinyl polymer part and the polyester part bind to each other.

3. The toner for electrostatic charge image development according to claim 1, wherein the metal salts of fatty acid are added at a ratio of 0.01 to 0.50 parts by weight relative to 100 parts by weight of the toner particles.

4. The toner for electrostatic charge image development according to claim 1, wherein the metal salts of fatty acid are at least one type selected from zinc stearate, lithium stearate, and calcium stearate.

5. The toner for electrostatic charge image development according to claim 1, wherein the metal salts of fatty acid are zinc stearate.

6. The toner for electrostatic charge image development according to claim 1, wherein the ratio of the metal salts of fatty acid that are liberated by the centrifugal treatment in an aqueous dispersion of the toner is 40 to 70%.

7. The toner for electrostatic charge image development according to claim 1, wherein the number average particle diameter of the particles that are present in a supernatant after the centrifugal treatment is 0.8 μm to 2.0 μm.

8. A two-component developer comprising a toner for electrostatic charge image development and a carrier for electrostatic charge image development, wherein the toner for electrostatic charge image development is the toner for electrostatic charge image development according to claim 1.

9. A method for forming an image by using the two-component developer according to claim 8, the method comprising a step of electrifying a surface of a photoreceptor by an electrifying roller which is installed to be in contact with the photoreceptor.
